(19) United States
(12) Patent Application Publication
(10) Pub. No.: US 2002/0113331 A1
(43) Pub. Date: Aug. 22, 2002

(54) Freeform fabrication method using extrusion of non-cross-linking reactive prepolymers

(76) Inventors: Tan Zhang, Auburn, AL (US); Zhimin Li, Auburn, AL (US); Lulu Song, Auburn, AL (US); Bor Zeng Jang, Auburn, AL (US)

Correspondence Address: Bor Z. Jang, 2076 S. Evergreen Dr., Auburn, AL, 36830, US

(21) Appl. No.: 09/742,829

(22) Filed: Dec. 20, 2000

(51) Int. Cl. B29C 41/02; B29C 41/52; G06F 19/00; G06F 17/50

(52) U.S. Cl. 264/40.1; 264/40.7; 264/75; 264/308; 700/119

(57) ABSTRACT

An extrusion-based freeform fabrication method for making a three-dimensional object from a design created on a computer, including (a) providing a support member; (b) operating a dispensing head having at least one dispensing nozzle with a discharge orifice for dispensing continuous strands of a material composition in a fluent state at a first temperature onto the support member, the material composition including a reactive prepolymer with a melting point above 23° C. and the first temperature being greater than the prepolymer melting point; (c) operating material treatment devices for causing the dispensed strands of material composition to rapidly achieve a rigid state in which the material composition is substantially solidified to build up the 3-D object, the material treatment devices also working to convert the reactive prepolymer to a higher molecular weight thermoplastic resin; and (d) operating control devices for generating control signals in response to coordinates of the object design to control the movement of the dispensing nozzle relative to the support member and for controlling the strand dispensing of the material composition to construct the 3-D object.

### FIELD OF THE INVENTION

This invention relates generally to a layer-additive manufacturing method that involves extrusion and deposition of a special class of material composition for the formation of a three-dimensional (3-D) object in an essentially point-by-point and layer-by-layer manner. Specifically, this material composition contains a reactive pre-polymer which helps to make the material composition in a fluent state in an extrusion device. The pre-polymer is capable of rapidly solidifying by chain extension after the material composition is dispensed out of the extrusion device in the form of a continuous strand of fluid.

### BACKGROUND OF THE INVENTION

The last decade has witnessed the emergence of a new frontier in the manufacturing technology, commonly referred to as solid free form fabrication (SFF) or layer manufacturing (LM). ALM process typically involves representing a 3-D object with a computer-aided design (CAD) geometry file. The file is then converted to a machine control command and tool path file that serves to drive and control a part-building tool (e.g., an extrusion head) for building parts essentially point-by-point or layer-by-layer. The LM processes were developed primarily for making concept models, molds and dies, and prototype parts. They are capable of producing a freeform solid object directly from a CAD model without part-specific tooling or human intervention. A SFF process also has potential as a cost-effective production process if the number of parts needed at a given time is relatively small. Use of SFF could reduce tool-making time and cost, and provide the opportunity to modify tool design without incurring high costs and lengthy time delays. A SFF process can be used to fabricate certain parts with a complex geometry which otherwise could not be practically made by traditional fabrication approaches such as machining.

Examples of more commonly used SFF techniques are stereo lithography (SLa), selective laser sintering (SLS), 3-D printing (3-DP), inkjet printing, laminated object manufacturing (LOM), fused deposition modeling (FDM), laser-assisted welding or cladding, and shape deposition modeling (SDM). In most of these techniques, the fabrication of a 3-D object either requires the utilization of expensive and difficult-to-handle materials or depends upon the operation of heavy, complex and expensive processing equipment. For instance, the photo-curable epoxy resin used in the stereo lithography process can cost up to US$200 per pound ($440 per kilogram). Melting of metallic, ceramic, and glass materials involves a high temperature and normally requires the utilization of expensive heating means such as an induction generator or a laser. Fully polymerized thermoplastics also require a moderately high temperature (normally in the range of 150° C. to 400° C.) to reach the molten state. Furthermore, thermoplastic melts are of high viscosity and relatively difficult to process.

A particularly useful SFF technique is based on the extrusion of heat-meltable materials or thermoplastics. The FDM (e.g., U.S. Pat. No. 5,121,329; Jun. 6, 1992 to S. S. Crump), an extrusion-based SFF process, operates by employing a heated nozzle to melt and extrude out a material such as nylon, ABS plastic (acrylonitrile-butadiene-styrene) and wax. The build material is supplied into the nozzle in the form of a rod or filament. The filament or rod is introduced into a channel of a nozzle inside which the rod or filament is driven by a motor and associated rollers to move like a piston. The front end, near a nozzle tip, of this piston is heated to become melted; the rear end or solid portion of this piston pushes the melted portion forward to exit through the nozzle tip. The nozzle is translated under the control of a computer system in accordance with previously sliced CAD data to trace out a 3-D object point by point and layer by layer. This process has a drawback that it requires a separate apparatus to pre-shape a build material into a precisely dimensioned rod or filament form. The re-melting of this rod or filament in a FDM nozzle requires additional heating elements placed around or inside the body of the nozzle. The nozzle has to be heated to at least 240° C. and 280° C. to thoroughly melt out ABS and nylon, respectively.

In a more general extrusion-based SFF process, a bulk quantity of materials such as thermoplastics and wax can be melted and directly transferred to a dispensing nozzle for deposition. It does not require the preparation of a raw material in a special shape, such as a filament in FDM, followed by re-melting. More general extrusion-based SFF processes can be found in U.S. Pat. No. 5,141,680 (Aug. 25, 1992) to Almquist and Smalley, U.S. Pat. No. 5,303,141 (Apr. 12, 1994) and U.S. Pat. No. 5,402,351 (Mar. 28, 1995) both to Batchelder, et al., and U.S. Pat. No. 5,656,230 (Aug. 12, 1997) to Khoshevis. In these examples, the starting material is heated to become a melt and then transferred to a dispensing head by using a fluid delivery device such as a gear pump, a positive-displacement valve, an air-operated valve, or an extruder. The nozzle also must be heated to maintain the material in the molten state prior to being extruded out for deposition. Wax materials, although processable at a relatively low temperature, are too weak and brittle. Again, the processing of fully polymerized thermoplastics require relatively high melting temperatures. Besides, it would take a more powerful screw extruder to deliver a highly viscous thermoplastic melt to a dispensing nozzle. Other less expensive fluid delivery devices by themselves, without the assistance of a screw extruder, are not effective in extruding out a continuous strand of thermoplastic melt.

Examples of extrusion-based SFF techniques using thermosetting resins are given in U.S. Pat. No. 5,134,569 (Jul. 28, 1992) to Masters and U.S. Pat. No. 5,204,124 (Apr. 20, 1993) to Secretan and Bayless. Both systems require the use of an ultra-violet (UV) beam or other high energy sources to rapidly cure a thermosetting resin which undergoes a cross-linking reaction for forming a three-dimensional, covalent-bonded network. Photo-curable or fast heat-curable resins are known to be expensive and the curing processes have very limited processing windows; curing of these materials has been inconsistent and difficult and the results have not been very repeatable. In general, the resulting materials, being highly cross-linked, are very brittle. Any residual thermoset resin not cleaned out of the fluid delivery device can clog up or ruin the device. This is because a thermoset resin, once thermally cured inside this device, can no longer be soluble in any solvent and cannot be melted again, making it impossible to clean up or remove.

In the present invention, a distinct type of material compositions is used in an extrusion-based SFF method. In this method, the dispensing of the material composition can be achieved at a relatively low temperature (e.g., in general lower than 200° C. and in many cases lower than 100° C.). The solidification of the material composition does not require either a high energy radiation source (like in the case of UV-curable resins) to achieve a cured state, or a great amount of heat energy to melt the material at a relatively high temperature and then a cooling means to help solidify the material (like in the case of fully polymerized thermoplastics). Instead, the build material composition is formulated to contain a lower molecular weight reactive precursor to a high polymer. Such a polymer precursor, with a relatively low melting point and low melt viscosity, is hereinafter referred to as a “prepolymer”. A prepolymer normally has a melting point higher than room temperature (Tm>23° C.) and, therefore, remains to be a solid material for easy handling at room temperature. The prepolymer, when heated to above its melting point, acts to make the build material composition in a fluent state prior to being dispensed. A range of prepolymers, being of low melting point, can be made to become a liquid at a temperature Tₗ being sufficiently low (e.g., Tₗ<100° C.) while residing in a fluid delivery device. This would not be possible if a fully polymerized thermoplastic were used due to a high viscosity and a high melting point (Tm) or glass transition temperature (Tg).

Two main strategies can be employed to heat treat the material composition after being dispensed from a fluid dispensing nozzle. In the first strategy, after being dispensed, the material composition containing the prepolymer is heated to a fast-reacting temperature (Tr) to advance the chain-extension polymerization (without cross-linking) in such a fashion that the melting point (Tₘ^{p}) of the resulting polymer quickly becomes higher than the reaction temperature (Tₘ^{p}>Tr). In this manner, the dispensed material quickly reaches a sufficiently rigid state, making it possible for multiple layers of materials to be stacked together and bonded to one another with a minimal part distortion. Prepolymers prepared from the ring-opening polymerization provide a good example for use in this strategy. Extrusion-based freeform fabrication of Nylon-6 materials was studied by Lombardi and Calvert (in Polymer, 40 (1999) pp. 1775-1779). However, monomer mixtures instead of oligomers were used in this study. Monomer mixtures tend to have much more volatile molecules being released during the polymerization reaction and, therefore, are less suitable for use in an office environment for producing 3-D concept models, for instance.

In a second strategy, the object-building zone is maintained at a temperature Tb that is lower than the melting point of the prepolymer (Tb<Tm). The dispensed material composition is quickly frozen or solidified at this build zone temperature, Tb. Upon completion of an individual layer, preferably upon completion of all layers, the dispensed and deposited material composition is then heat treated at a temperature Th that is equal to or slightly lower than the prepolymer melting point (Th≦Tm). The conversion of the prepolymer proceeds in solid state so that the dispensed material no longer flows to change the object dimension. Examples of prepolymers that can be utilized to practice this strategy are those prepared from step-growth polymerizations. The melting points of this class of prepolymers or oligomers can be tailor-made to fall into the preferred range of 25° C.<Tm<250° C., and most preferred range of 25° C. <125° C. As another example, the SFF method may involve the extrusion of cyclic oligomer or prepolymer strands at a slightly higher temperature (e.g., 200° C. to 300° C.) by using an extrusion device. These prepolymers or oligomers, formulated based on the “cyclics” polymer technology, are of much lower viscosity while residing in a fluid delivery device as compared to their higher molecular weight counterparts. Once dispensed out of such a device to form a part of the 3D object being built, these prepolymer strands can be converted to high molecular weight linear polymers that have excellent strength, toughness, thermal stability, and solvent resistance.

In the presently invented method, since no significant cross-linking reaction occurs to the prepolymer while being converted to a high molecular weight thermoplastic resin, the fluid delivery device or dispensing nozzle would not be clogged up with insoluble or un-meltable resin like in the case of thermoset resins. The resulting thermoplastic polymers are of good strength and toughness. In contrast, a cross-linked thermoset resin tends to be very brittle.

### OBJECTS OF THE INVENTION

An object of the present invention is to provide an improved layer-additive method to fabricate a three-dimensional object with good mechanical integrity from a less expensive class of materials in an essentially point-by-point and layer-by-layer manner.

Another object of the present invention is to provide an improved method that can automatically reproduce a 3-D object directly from a computer-generated data file representing this object.

Yet another object of the present invention is to provide a method for producing a 3-D part without the use of a part-specific tooling or human intervention.

A specific object of the present invention is to provide a simple and cost-effective freeform fabrication method for building a 3-D object using a material composition in an easy-to-handle physical state, without using heavy and expensive equipment. This material composition covers a wide range of polymeric materials.

### BRIEF SUMMARY OF THE INVENTION

The above objects are realized by a method which begins with the creation of a computer-aided design (also referred to as a drawing, an image, or a geometry representation) of a three-dimensional object. The method then involves providing a support member by which the object is supported while being constructed. It also involves operating a material dispensing head for dispensing continuous strands of a material composition in a fluent state. This material composition includes a reactive prepolymer at a first temperature (Tₗ) higher than the melting point (Tm) of this prepolymer so as to make the material composition in a fluent state while still residing in a liquid chamber or flow path of the dispensing head. The method further includes operating material treatment means disposed near the dispensed strands for causing the material composition in the strands to rapidly achieve a rigid state in which the material composition is substantially solidified and built up in a form of this 3-D object. The ultimate goal of the material treatment procedures is to convert the reactive prepolymer to a higher molecular weight, substantially linear-chain thermoplastic resin with a balance of good mechanical properties. The method also includes operating a computer and machine controller for generating control signals in response to coordinates of the object design and controlling the position of the dispensing head relative to the support member in response to the control signals to control strand dispensing of the material composition for constructing the object. Specifically, the dispensed strands of material composition are deposited in multiple layers which solidify and adhere to one another to build up the object.

Drive means such as servo motors or stepper motors are provided to selectively move the support member and dispensing head relative to each other in a predetermined pattern along a direction parallel to an X-Y plane defined by first (X) and second (Y) coordinate axes as the material composition is being dispensed to form a layer. After one layer is built, the dispensing head and the support member are moved away from each other in a third (Z) direction by a predetermined layer thickness. The X-, Y-, and Z-directions form a Cartesian coordinate system. The same procedures of moving and droplet dispensing are then repeated to form each successive layer with each layer having its own characteristic shape and dimensions. Such mechanical movements are preferably achieved through drive signals inputted to the drive motors for the support member and the dispensing head from a computer or a controller/indexer (servo means) supported by a computer. The computer may have a CAD/CAM software to design and create the object to be formed. Specifically, the software is utilized to convert the 3-D shape of an intended object into multiple layer data, which is transmitted as drive signals through a controller to the drive motors. Each individual computer-generated layer has its own shape, dimensions, and thickness. It is the combination and consolidation of these constituent layers that form a complete 3-D shape of the object.

In one preferred embodiment, the material treatment means comprise heating means to heat up the dispensed strands of the material composition to a second temperature (Tr) being approximately equal to or higher than the first temperature (i.e., Tr>Tₗ) so as to rapidly convert the prepolymer to a higher molecular weight thermoplastic resin with a new melting point (Tₘ^{p}) higher than the second temperature (Tₘ^{p}>Tr). Prepolymer materials that can be employed to achieve this goal include nylon-6 oligomers obtained by the ring-opening polymerization. The material composition may include a catalyst and/or accelerator for promoting the conversion of the prepolymer to a higher molecular thermoplastic resin. In this particular example of nylon-6, the prepolymer may contain an activated anionic chain from caprolactam.

In another preferred embodiment, the material treatment means comprise (a) providing a forming environment (in the object-building zone above the support member) with the environment being at a second temperature Tb that is substantially lower than the first temperature Tₗ to facilitate the solidification of the dispensed strands; and (b) heating means to heat the 3-D object for converting the prepolymer at a third temperature (Th) being approximately equal to or lower than the melting point of the prepolymer (Th≦Tm) so as to execute the conversion procedure in a substantially rigid or solid state. Procedure (b) may be carried out after each layer is deposited, but is preferably carried out after all constituent layers are deposited. This final heat treatment can be carried out in situ on the support member, but is preferably conducted in a separate oven so that the freeform fabrication apparatus can be used to fabricate additional objects. Essentially all oligomers prepared by step-growth polymerizations and “cyclic oilgomer” approaches can be used for this method. The step-growth prepolymer may be selected from the group consisting of oligomer precursors to linear polyester, polyamide, polyurethane, polyimide, polysulfide, and copolymers thereof. The cyclic oligomer may be selected from the group consisting of cyclic organic carbonate, thiocarbonate, heterocarbonate, imide, polyphenylene ether-polycarbonate, ester, amide, etherketone, ethersulfone, and mixtures thereof.

The dispensing head may include a fluid delivery device or just a chamber to accommodate the material composition. In one embodiment, the fluid delivery device is an extruder means connected to a single- or multiple-channel material-feeding module. The extruder is preferably equipped with heating means to melt out the incoming feedstock material compositions. The extruder, through the counter rotating movement of a screw being driven by a motor means, moves the feedstock material forward and dispenses the melted material composition through a dispensing nozzle in an essentially continuous strand form to deposit the first layer onto the object-supporting platform. The extrusion procedure is continued to deposit a second layer that adheres to the first layer. This process is repeated until all the layers are deposited to form an object. The contour or cross section of each layer is defined by the CAD-generated data file. This type of extruder-based fluid delivery device is particularly useful for handling feedstock material compositions in the form of particulate, such as small prepolymer granule, pellet, flake, and powder that can be readily melted. The fluid delivery device may also be selected from the group consisting of a gear pump, positive-displacement pump, air-operated pump, syringe, metering pump, solenoid valve, or combinations thereof. The dispensing head may comprise a plurality of strand-dispensing nozzles with a plurality of discharge orifices for producing a multiplicity of substantially continuous strands of the material composition simultaneously or sequentially. The material composition from an orifice may contain one colorant. With a plurality of nozzle orifices extruding strands of different material compositions (including different colorants), the presently invented method is capable of fabricating multi-material and multi-color objects.

### Applications and Advantages of the Present Invention

More Versatile Rapid Prototyping: The present invention provides a simple yet versatile method of rapid prototyping. Due to the versatility of this method, a user of this method is free to choose a reactive prepolymer from a wide spectrum of chemical compositions. A wide range of material compositions may be combined to form an article with a desired combination of physical and chemical properties. The present method is capable of fabricating multi-material and/or multi-color objects of any complex shape in a point-by-point and layer-by-layer fashion under the control of a computer.

More Cost-Effective Model Making: The present method imposes a minimal constraint on the selection of various material ingredients. For the purpose of creating a concept model, one has a wide range of inexpensive materials at his/her disposal. In contrast, the FDM process requires the preparation of a filamentary feed material that involves a tedious procedure similar to polymer extrusion followed by fiber spinning. The filament is then fed into a nozzle and re-melted to a liquid state. Selective laser sintering requires preparation of ceramic powder particles with thin polymer coatings. These exotic build materials are difficult to prepare and are very expensive. Processes such as stereo lithograph involves laser curing of expensive photo-curable epoxy or acrylic resins (up to US$200 per pound or $440 per kilogram).

Simple and Less Expensive Fabrication Equipment Design: The presently invented approach makes it possible to have a simple dispensing head design. For instance, fully polymerized thermoplastic melts are normally highly viscous and, hence, difficult to pump, extrude, or eject out of a small orifice due to a high capillarity pressure that must be overcome. The utilization of a prepolymer or oligomer, with a relatively low melting point and of low viscosity will make it easier to prepare a flowable material composition. A wide range of fluid delivery devices can be chosen for use in the present method. For instance, small gear pumps are relatively inexpensive and fluid delivery operations using a gear pump have been a well-developed technology. It would be advantageous to make use of a gear pump to deliver the material composition in fluid state directly to a dispensing nozzle without using a more expensive extruder, for instance. It would be extremely difficult, if not impossible, for a gear pump alone to deliver a highly viscous thermoplastic melt if this thermoplastic is a fully polymerized resin with a sufficiently high molecular weight for material strength. Fortunately, the present invention provides a wide range of reactive prepolymers that form a low-viscosity fluid at a temperature not much higher than ambient temperature (e.g., lower than 250° C. in general and, in many cases, lower than 100° C.). These prepolymers can be readily converted to longer-chain, substantially linear polymers that are thermoplastic in nature. Thermoplastic resins are known to have a good balance of toughness, ductility, strength, and stiffness. By using thermoplastic precursor oligomers, the dispensing head nozzle design can be much less complex. No exotic, fancy or complex fluid delivery device is required. This will also make the control and operation of the present SFF system simple and reliable.

It may be further noted that, in principle, a thermosetting resin can also have a low viscosity before curing and, therefore, can be easily extruded into a continuous strand form. Thermoset resins suffer from the at least three shortcomings, however. First, fast-curing thermosetting resins normally require curing by a high energy radiation source (e.g., photocurable epoxy by a laser beam). Second, thermoset resins, once heated, would gradually get cured and tend to clog up the nozzle orifice and other portions of a liquid flow path in a dispensing device. The device would have to be discarded since highly cross-linked thermoset resins are not soluble or fusable (intractable), making it extremely difficult if not impossible to clean up the flow path and remove the clog. Third, the thermoset resins are normally much more brittle and, therefore, the resulting 3-D objects are of poor mechanical integrity.

These and other advantages of the invention will become readily apparent as one reads through the following description of preferred embodiments and the accompanying drawings.

### BRIEF DESCRIPTION OF THE DRAWINGS

FIG. 1 Schematic of a layer manufacturing system.

FIG. 2 Schematic of an extruder used as a fluid delivery device in a strand-dispensing head for building a 3-D object layer by layer.

FIG. 3 Schematic of (a) a gear pump, (b) an air-operated pump, and (c) piston-driven pump used as a fluid delivery device in a strand-dispensing head for building a 3-D object layer by layer.

FIG. 4 A flow chart showing the sequence of creating a 3-D object by a CAD software program, establishing layer-by-layer database by layering software, and sending out motion-controlling signals by a computer to the drive motors through a motion controller.

FIG. 5 Schematic of typical relationships between the melting point or glass transition temperature of a growing prepolymer and the step-growth reaction time.

FIG. 6 A well-known relation between the zero-shear viscosity and molecular weight of a polymer. A lower viscosity is more favorable to droplet production.

### DESCRIPTION OF THE PREFERRED EMBODIMENTS

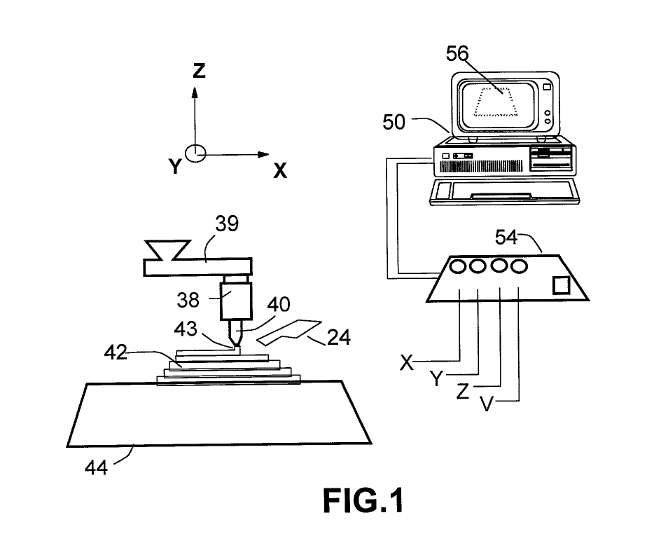

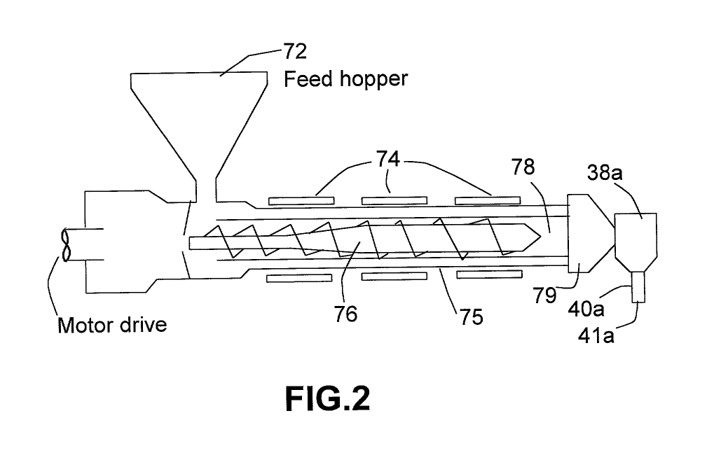

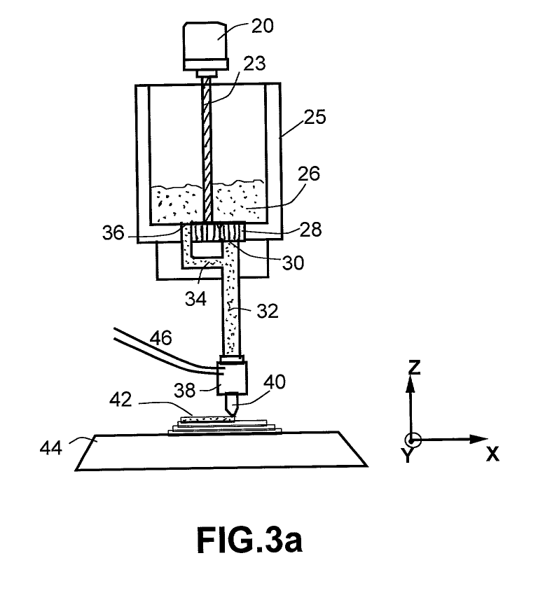

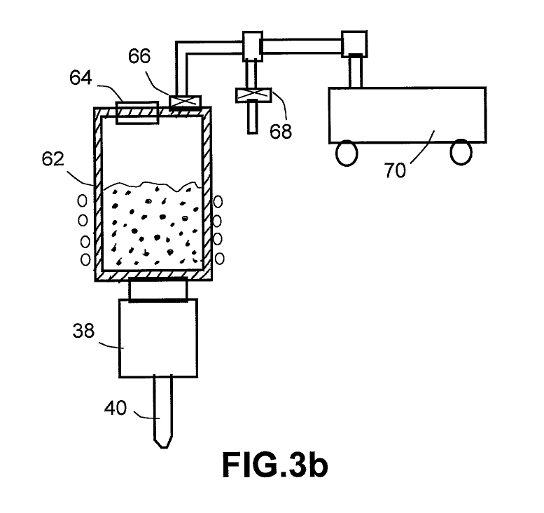

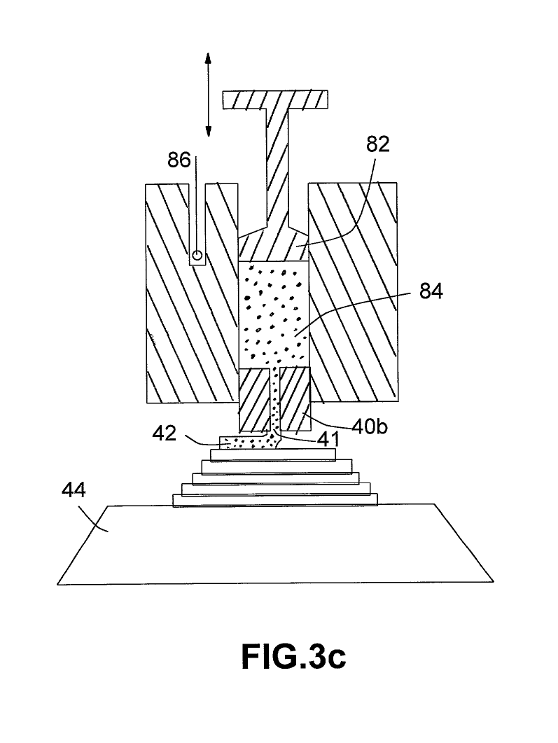

FIG. 1 illustrates one preferred embodiment of the presently invented method for making a three-dimensional (3-D) object. This method begins with the creation of a computer-aided design 56 (a drawing, image, or geometry representation) of a three-dimensional object using a computer 50. This method involves the operation of a system that includes computer software and control hardware (e.g., motion controller/indexer 54). The system further includes a support member 44 by which the object 42 is supported while being constructed. The system also has a material dispensing head 37 for dispensing continuous strands 43 (FIG. 2 and FIG. 3c) of a material composition in a fluent state. Preferably, this dispensing head comprises a fluid delivery device such as a screw extruder 39 (FIG. 1) that delivers the material composition through a control valve 38 (e.g., a solenoid valve) to a dispensing nozzle 40. The fluid delivery device can be an extruder (FIG. 2), a gear pump (FIG. 3a), an air-operated pump (FIG. 3b), a piston-driven pump (FIG. 3c), a positive-displacement pump, a syringe, or any other fluid-metering device. The dispensing nozzle 40 has at least a discharge orifice (e.g., 41a in FIG. 2 and 41 in FIG. 3c) of a predetermined size through which a continuous strand of fluid can be extruded. The material composition includes a low-molecular weight oligomer or prepolymer that helps to make the material composition in a fluent state while still residing in the control valve 38 and the dispensing nozzle 40. A predetermined amount of the material composition may be delivered to the dispensing head (40 in FIG. 1, 41a in FIG. 2, or 41b in FIG. 3c) at a first temperature Tₗ before the build process begins. The strand of material is dispensed and deposited to a surface of the support member essentially point by point to build the first layer of the object.

In one preferred embodiment, the method further includes operating material treatment means (e.g., a heating device such as a radiant heater or a hot air blower 24) disposed near the deposited strands of material composition for converting the prepolymer to a longer chain polymer and, hence, causing the dispensed material composition to rapidly achieve a rigid state in which the material composition is substantially solidified. This rapid solidification is achieved by heating the prepolymer in the dispensed strands to a fast-reacting temperature Tr (Tr≧Tₗ) so as to rapidly advance the chain-extension polymerization (without cross-linking) in such a fashion that the melting point (Tₘ^{p}) of the resulting polymer quickly becomes higher than the reaction temperature (i.e., Tₘ^{p}>Tr). Since the environment temperature Tr surrounding the object being built is always lower than the ever-increasing melting point Tₘ^{p} of the growing polymer chains, the dispensed strands of material composition will always stay in a sufficiently rigid or solid state during the object-building process. The procedures are repeated to dispense and build successive layers of the 3-D object in a point-by-point and layer-by-layer fashion.

Alternatively, as another preferred embodiment of the present invention, the material treatment means can include (a) providing a build zone temperature (Tb) lower than the softening temperature (Tm or Tg) of the dispensed prepolymer strands so as to rapidly solidify these strands (but still allowing sufficient time for the strands to adhere to one another in the same layer and adhere to the material in a preceding layer); and (b) subjecting the deposited layers to a temperature (Th) substantially close to or slightly below the softening temperature in such a manner that the conversion of the prepolymer to a higher molecular weight polymer proceeds essentially in a solid state to avoid any significant shape change. It is well known that the Tg or Tm of a growing polymer sample increases as the chain extension reaction proceeds with time. This implies that the heat treatment temperature Th may be adjusted accordingly, provided that Th does not exceed the Tg or Tm of the reacting polymer for any significant period of time. Step (b) may be executed after each layer is deposited, but is preferably done after all constituent layers of the object are deposited.

The method also includes operating a computer 50 for generating control signals in response to coordinates of the design of this object and operating the controller/indexer 54 for controlling the position of the dispensing head relative to the support member in response to the control signals. During the steps of moving the dispensing head relative to the support member, the dispensing nozzle 40 is also controlled to dispense the material composition, continuously or intermittently on demand, for constructing the object 42 while supported with the support member 44. Specifically, the dispensed material composition is deposited in multiple layers which solidify and adhere to one another to build up the object. The line cords X, Y, and Z in FIG. 1 serve to electronically control the X-, Y-, and Z-directional motions of the dispensing nozzle 40 relative to the support member 44 while line cord V serves to control the material dispensing operation of the dispensing head.

The fluent material composition may be composed of a prepolymer (in a fluid state), an optional catalyst, an optional reaction promoter or accelerator, and other optional additives such as a colorant. This material composition is capable of solidifying rapidly after being dispensed out of an orifice (e.g., 41 in FIG. 3c) at the bottom portion of the dispensing nozzle (e.g., 40b in FIG. 3c) to deposit onto a surface of a moveable support member 44. As indicated earlier, this rapid solidification is made possible by either (a) rapidly advancing the polymerization of the prepolymer in the dispensed material composition into a longer-chain thermoplastic resin or (b) quenching the dispensed strands to a temperature Tb much lower than the Tm of the prepolymer and then advancing the polymer conversion at a temperature Th near or slightly lower than this Tm at a later stage so that this chain extension or polymer conversion procedure takes place in an essentially solid state. In case (a), the process begins with the deposition of a first layer with part or all of the prepolymer being converted to its higher molecular weight counterpart prior to deposition of a second layer. The step of polymer conversion in the first layer could continue when the second and subsequent layers are being built. Similarly, the polymer conversion in the second layer could continue when the third and subsequent layers are being dispensed and deposited. These steps are repeated until all constituent layers of the 3-D object are deposited. At this moment of time, a portion of the prepolymer may possibly still remain as oligomers in the fabricated 3-D shape, which can be subjected to a further treatment at a later stage to complete the polymer conversion process. In case (b), polymer conversion may be allowed to proceed after a layer is built or after several layers are deposited, but most preferably after all layers of the 3-D body are deposited. This treatment may be carried out either in situ above the support member surface in the SFF apparatus or, preferably, in a separate oven after the SFF process is completed. This would allow the SFF apparatus to build additional 3-D bodies while the already SFF-fabricated bodies are being further heat treated in a separate oven.

### Material Compositions and Treatment Conditions

The discharged material composition that comes in contact with the support member or a previous layer must meet two conditions. The first condition is that this material must quickly exhibit a sufficiently high viscosity to prevent excessive flow (or spreading) when being deposited; this is required in order to achieve a good dimensional accuracy. The second condition is that the newly discharged material must be able to adhere to a previous layer. These two conditions can be met by discharging the following material compositions containing three major types of prepolymers that can be rapidly converted to linear polymers of relatively high molecular weights. It may be noted that a variety of additives or reinforcements may be added to the prepolymer to impart desired physical and chemical properties to the resulting material compositions. Additives could include an anti-oxidant, flame retardant, toughening agent, plasticizer, anti-static agent, or combinations thereof. Reinforcements could include particulates, fibers, whiskers that are ceramic, glassy, polymeric, or carbonaceous in nature.

### Type I Prepolymers (Oligomers Prepared by the Step-growth Polymerization)

The first type of prepolymer used in the present invention is the low molecular weight oligomers prepared by the step-growth polymerization. The present step-growth polymerizations fall into two groups depending on the type of monomers employed. The first involves two different bi-functional monomers in which each monomer possesses only one type of functional group. The second involves a single bi-functional monomer containing both types of functional groups. For instance, polyamides can be obtained from the reaction of diamines with diacids:

n H₂N—R—NH₂+n HOOC—R′—COOH→H—(NH—R—NHCO—R′—CO)ₙ—OH+(2n−1)H₂O (Eq. 1)

or from the reaction of amino acids with themselves:

n H₂N—R—COOH→H—(NH—R—CO)ₙ—OH+(n−1)H₂O (Eq.2)

where the chain linkage groups R and R′ are typically selected from methylene groups —(CH₂)ₓ—. Another example of the step-growth polymerization is the preparation of polyester from a diol and a diacid:

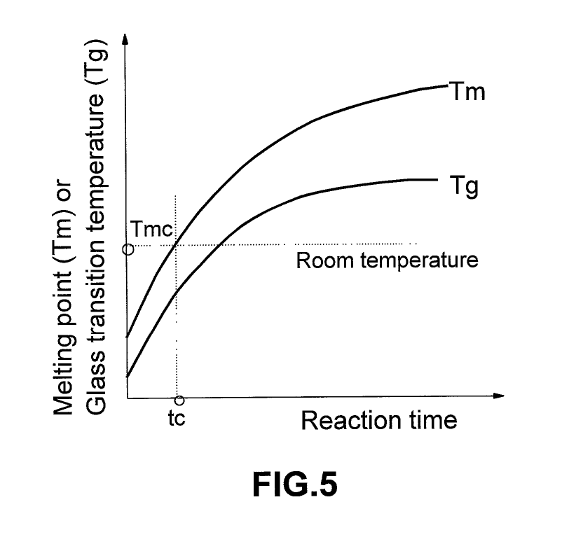

n HO—R—OH+n HOOC—R′—COOH→H—(O—R—OCO—R′—CO)ₙ—OH+(2n−1)H₂O (Eq.3)

where R and R′ can be selected from both aliphatic groups such as methylene or ether linkage and/or aromatic groups. A well-known feature of step-growth polymerizations is that the molecular weight (Mw) of the growing polymer chains increases steadily as a function of reaction time or extent of reaction, p. Furthermore, the melting point (Tm) or glass transition temperature (Tg) of the resulting polymer increases with the increasing chain length or molecular weight. This normally leads to the monotonically increasing relations of Tm (for a semi-crystalline polymer) and Tg (for an amorphous thermoplastic polymer) with respect to the reaction time as schematically indicated in FIG. 5.

Since the molecular weight, Tm, and Tg of the growing chains are a function of the reaction time, the desired Mw, Tm, and Tg can be obtained by quenching the reaction (e.g., by cooling the reacting mass) at the appropriate time (e.g., by selecting a time t>tc in FIG. 5). Conventional wisdom has it that this is not a desirable approach to the control of these desirable physical properties (Mw, Tm, and Tg). This is because the polymer obtained in this manner is unstable in that subsequent heating (back to room temperature or an end-use temperature, e.g.) leads to changes in Mw due to the polymer chain ends containing functional groups which can react further with each other. This statement is valid provided that the polymer obtained would be used as synthesized, without a further treatment. In the present invention, however, this quenching approach can be effectively used to prepare a prepolymer or oligomer with predetermined Mw, Tm and Tg characteristics so that the prepolymer would be in a low-viscosity state for extrusion at a proper temperature (e.g., preferably lower than 200° C. and more preferably lower than 100° C. Specific manners in which one can take advantage of this quenching approach are explained as follows:

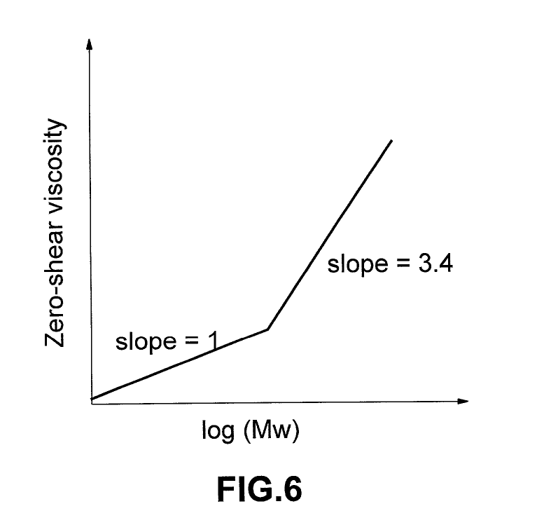

In one preferred embodiment of the present invention, referring again to FIG. 5, a prepolymer can be obtained by allowing the step-growth polymerization to proceed to an extent such that the resulting prepolymer has a Tm (if crystalline polymer) or Tg (if amorphous polymer) greater than room temperature (25° C.) and then rapidly cool down (quench) the reacting mass to a temperature much lower than the room temperature to essentially “freeze” the polymerization reactions. This prepolymer is maintained at room temperature or below (so that it is in a solid state for easy handling) prior to being introduced into the fluid delivery device. When it is ready to begin the freeform fabrication process, the fluid delivery device and dispensing nozzle may be heated to slightly above the Tm or Tg of the prepolymer to reach a low-viscosity state. The prepolymer melt is of low viscosity because it has a relatively low molecular weight. A well-known relationship between the viscosity and the Mw of a polymer is schematically shown in FIG. 6. A relatively low viscosity is essential to the successful extrusion of liquid strands through a minute discharge orifice in a dispensing nozzle.

The strands of material composition, once dispensed and deposited to form a part of a layer, may be subjected to further treatments. Two treatment strategies have been successfully implemented. The first includes setting up a high temperature environment at the object-building zone so that rapid solidification of the dispensed strands is achieved by heating the prepolymer to a fast-reacting temperature that rapidly extends the chain length of the prepolymer. A reaction catalyst and/or accelerator may be added to the prepolymer, prior to strand extrusion, to promote the chain extension reaction. This treatment strategy works only for those prepolymers that undergo fast polymer conversion reactions. The second and more widely applicable strategy involves (a) setting up an object-building zone temperature Tb lower than the softening temperature (Tm or Tg) of the dispensed prepolymer so as to rapidly solidify these strands; and (b) upon completion of the multi-layer deposition process, subjecting the deposited layers to a temperature slightly below the softening temperature for converting the prepolymer to a high molecular weight polymer. This final conversion of linear polymer can proceed in the solid state at a reasonable rate. This solid state reaction does not inflict any significant shape change to the 3-D object. This heat treatment temperature can be allowed to go up with treatment time in accordance with the softening point of the growing chains which normally increases with the extent of reaction, as indicated in FIG. 5. This approach of steadily increasing heat treatment temperature helps reduce the time required for completing the chain extension process.

### EXAMPLE 1

Polyesterification of adipic acid (—R′—═—(CH₂)₄— in Eq.3) with diethylene glycol (R—═—(CH₂)₂—O—(CH₂)₂— in Eq.3) at 109° C. catalyzed by 0.4 mole % p-toluenesulfonic acid. A prepolymer, polyester oligomer, was obtained by allowing the above reactant mixture to proceed for 10 hours at 109° C. The reacting mass was quenched to a dry ice bath to tentatively freeze the reaction. The resulting oligomer had a degree of polymerization of approximately 75, corresponding to a molecular weight of 8,330 g/mole. The prepolymer was reheated to 70° C. in the resin reservoir of a gear pump and a dispensing nozzle, which extrudes strands of prepolymer onto a build zone at a temperature of 20° C. The strands solidified and adhered to each other to build a 3-D body in accordance with the presently invented process. The 3-D body was then further heat treated in an oven at 35° C. for one hour, 45° two hours, and 55° C. for three hours.

### EXAMPLE 2

Preparation of polyamide 6/6 prepolymer from hexamethylene diamine (—R—═—CH₂)₆— in Eq.1) and adipic acid (—R′—═—(CH₂)₄— in Eq.1). The monomer mixture with a stoichiometric balance of amine and carboxyl groups was heated at 200° C. to produce a 1:1 ammonium salt, or nylon salt. The prepolymer was prepared by heating an aqueous slurry of approximately 70% of the nylon salt at 200° C. in a closed autoclave under a pressure of approximately 15 atmospheres. This direct amidation process proceeded for approximately 2 hours to obtain an approximately 85% prepolymer conversion. The prepolymer bulk was size-reduced to powder form, which was later used and heated in a dispensing head. Strands of this prepolymer were extruded at 285° C. by a screw extruder onto an object build zone with a Tb=25°-75° C. The solidification of these extruded strands could be allowed to occur at any temperature Tb lower than 200° C., but preferably lower than 75° C. A temperature 35° C. was used in the present example. The resulting multi-layer 3-D object was of sufficiently high toughness and strength for use as a concept model. If a higher mechanical integrity of the 3-D object is desired, the object could be subjected to a final polymer conversion treatment at a temperature of 250-260° C. This solid state conversion process could last for 1-10 hours, depending on the desired molecular weight of the resulting linear high polymer.

### EXAMPLE 3

Copolymers of Polyethylene Terephthalate and Polyoxyethylene Glycol. The monomer mixture of dimethyl terephthalate and ethylene glycol at an 1:1 ratio was mixed with a desired amount of polyoxyethylene glycol (Mw=2800 g/mole) and a trace amount of titanium oxide as catalyst. The reacting mass was heated at 200° C. for approximately 4 hours in a vapor bath with the methanol being distilled and collected continuously. The resulting prepolymer was maintained at 275° C. in a screw extruder for a predetermined length of time (between 10 and 60 minutes under a nitrogen blanket). The strands were then dispensed to an object-building zone at room temperature. The resulting multi-layer body was then placed in a vacuum oven at 200° C. for one hour, 230° C. for two hours, and 250° C. for three hours.

### Type 2 Prepolymers (Linear Oligomers Prepared by Ring-opening Polymerization of Cyclic Monomers)

The second type of prepolymers that can be employed in the present invention are oligomers that are prepared from the ring-opening polymerization of cyclic monomers such as ethers, acetals, esters, amides, amines, sulfides, siloxanes and mixtures thereof. Most ring-opening polymerizations behave as step-growth polymerizations in that the polymer molecular weight increases steadily throughout the course of the polymerization. This implies that the same strategies used in the preparation of step-growing oligomers (Type 1 Prepolymer) for solidification control and polymer conversions can be employed in the extrusion and deposition of prepolymer strands prepared from the ring-opening polymerization of cyclic monomers.

Specifically, the ring-opening polymerization of a cyclic monomer is allowed to proceed to an extent in which the growing chains have predetermined Mw, Tm, and Tg values, with Tm or Tg higher than room temperature but preferably lower than 100° C. The reacting mass is then quenched (e.g., rapidly cooled to liquid nitrogen or dry ice temperatures) to freeze the polymerizing reaction. The prepolymer solid is then heated back to above the Tm or Tg to become a liquid in the resin reservoir of a dispensing nozzle just prior to strand extrusion. In one preferred embodiment of the present invention, the extruded and deposited strands are solidified by providing a lower temperature environment near the object-building zone. Once the 3-D body is made, it is subjected to a polymer conversion treatment at a temperature comparable to (but slightly lower than) the current Tm or Tg of the deposited prepolymer. The prepolymer will be converted to a higher molecular weight polymer under solid state conditions. In another preferred embodiment, the dispensed and deposited strands are subjected to a fast-reacting temperature Tr, equal to or higher than the strand extrusion temperature, so as to rapidly convert the prepolymer into a high Mw, non-cross-linked polymer and, thereby, solidifying the polymer while the layers are being built.

### EXAMPLES 4a-4d

Prepolymers for Nylon 6. The production of nylon-6 via ring-opening of ∈-caprolactam may begin with the preparation of a prepolymer under the conditions specified in Table 1. Sample 4-a prepolymer was prepared by the sodium hydride-catalyzed ring-opening polymerization of caprolactam at 230° C. for 30 minutes. The reacting mass was subsequently quenched to −50° C. to substantially freeze the polymerization. This oligomer sample remained in the solid state at room temperature, 23° C. This prepolymer was blended with a small amount of activator (0.5% N-acylcaprolactam) and the resulting mixture was re-heated back to 100° C. inside the resin reservoir of a gear pump. The prepolymer liquid was extruded at this temperature Te=Tₗ=100° C. out of a dispensing nozzle to the object-building zone above the support member; this build zone being maintained at Tb=160° C. At this temperature, the dispensed prepolymer strands underwent a rapid reaction for extending the chain length of the polymer, which became solidified to permit layer-wise build-up of a 3-D body. This 3-D body was then placed in an oven preset at 170° C. to further advance the polymer conversion which took place in a solid state.

TABLE 1
Four examples illustrating the preparation of caprolactam oligomers and
conversion of these oligomers to high molecular weight nylon-6 polymers.

| | | | Ring-opening | Extrusion T | Subsequent |
|---|---|---|---|---|---|
| Sample | | | polymerization | and build | treatment |
| No. | Catalyst | Co-catalyst or activator | temperature and time | zone T, ° C. | conditions |
| 4-a | sodium | N-acylcaprolactam, | 230° C. for 30 min.; | Te = 100° C. | 170° C. for 60 |
| | hydride, 1 | 0.5% added after | quenched to −50° C. | Tb = 160° C. | minutes |
| | mol. % | prepolymer was made | | | |
| 4-b | sodium | TMXDI, 0.5% | 80° C. for 10 min., | Te = 100° C. | 80° C. for 30 min., |
| | hydride, | | quenched to −50° C. | Tb = 23° C. | 90° C. for 30 min., |
| | 0.5 mol. % | | | | & 160° C. for 1 |
| | | | | | hour |
| 4-c | TMXDI, 1 | Sodium caprolactamate, | 70° C. for 10 min., | Te = 100° C. | 170° C. for 60 |
| | mol. % | 2 mol. % | quenched to −50° C. | Tb = 160° C. | minutes |
| 4-d | TMI, 1 | Sodium caprolactamate, | 70° C. for 15 min., | Te = 100° C. | 170° C. for 60 |
| | mol. % | 2 mol. % | quenched to −50° C. | Tb = 160° C. | minutes |

Note:
TMXDI = tetramethyl-1,3-xylylene diisocyanate;
TMI = 3-isopropenyl dimethylbenzyl isocyanate.

In Example 4b, the prepolymer was prepared by mixing caprolactam monomer with 0.5 mol. % of sodium hydride as a catalyst and 0.5% of TMXDI as an activator. The mixture was allowed to react at 80° C. for 10 minutes prior to being quenched to −50° C. The reacting mass was re-heated to 100° C. prior to being extruded out of a dispensing nozzle into a build zone at Tb=23° C. for rapid solidification. These solidified prepolymer strands were deposited and built up layer by layer to form a 3-D body, which was removed from the build zone and placed in an oven for further treatments. A tough nylon-6 object was obtained after a heat treatment schedule of 80° C. for 30 min., 90° C. for 30 min., and 160° C. for 1 hour.

In Example 4-c, caprolactam monomer along with 1 mol. % of TMSDI and 2 mol. % of sodium caprolactam was heated at 70° C. for 10 minutes to produce an oligomer mass, which was quenched to −50° C. This prepolymer sample was re-heated to 100° C. for extrusion into strands which were directed to deposit in a build zone of 160° C. to build up a 3-D object layer by layer.

At this temperature, the conversion of oligomers into a large Mw polymer occurred rapidly, presumably pushing the Tm of the resulting polymer above approximately 200° C. Upon completion of a further heat treatment of 170° C. in an oven for 1 hour, the nylon-6 polymer was found to exhibit a Tm of approximately 216° C.

In Example 4-d, the catalyst employed was TMI with other preparation and treatment conditions being comparable to those in Example 4-c.

### Type 3 Prepolymer (Cyclic Oligomersfrom “Cyclics” Technology)

A third type of prepolymers that can be used in the presently invented method include the cyclic oligomers prepared by a relatively new synthesis approach commonly referred to as the “cyclics” technology developed primarily by scientists at the General Electric Co. This technology was disclosed in the following U.S. Pat. No. 4,644,053 (Feb. 17, 1987 to Brunelle, et al.), U.S. Pat. No. 4,696,998 (Sep. 29, 1987 to Brunelle, et al.), U.S. Pat. No. 4,837,298 (Jun. 6, 1989 to Cella, et al.), U.S. Pat. No. 4,789,725 (Dec. 6, 1988 to Guggenheim, et a..), U.S. Pat. No. 4,757,132 (Jul. 12, 1988 to Brunelle, et al.), U.S. Pat. No. 4,808,754 (Feb. 28, 1989 to Guggenheim, et al.), U.S. Pat. No. 4,736,016 (Apr. 5, 1988 to Brunelle, et al.), U.S. Pat. No. 4,980,453 (Dec. 25, 1990 to Brunelle, et al.), U.S. Pat. No. 4,880,899 (Nov. 14, 1989 to Guggenheim, et al.), U.S. Pat. No. 4,853,459 (Aug. 1, 1989 to Stewart), U.S. Pat. No. 4,829,144 (May 9, 1989 to Brunelle, et al.), U.S. Pat. No. 4,814,429 (Mar. 21, 1989 to Silva), and U.S. Pat. No. 4,927,904 (May 22, 1990 to Guggenheim, et al.). These cyclic oligomers cover a wide range of chemical linkages including cyclic organic carbonate, thiocarbonate, heterocarbonates (containing linkages such as ester, urethane, imide, ether sulfone, ether ketone, or amide), imides, polyphenylene ether-polycarbonate, esters, amides, etherketones, ethersulfones, and mixtures thereof.

These cyclic oligomers have the following common features that make them particularly well-suited for use in the present freeform fabrication method: (1) these oligomers have melting points higher than room temperature (normally 140° C.<Tm<300° C.; mostly between 200° and 250° C.); (2) presumably due to the ease of oligomer cyclics sliding over one another, they have a relatively low viscosity at T>Tm; and (3) they can be easily converted to high molecular weight linear polymers or copolymers with excellent mechanical, physical, and chemical properties. These features have made it possible to carry out freeform fabrication of 3-D objects according to the following general procedures: (i) heating a cyclic oligomer sample above its melting point, introducing this liquid to a fluid delivery device, and optionally adding any catalyst and/or accelerator for promoting the subsequent polymerization; (ii) extruding out oligomer strands to an object-building zone at room temperature (or at any temperature substantially lower than the Tm of the oligomer) to facilitate fast solidification and formation of a 3-D body essentially point by point and layer by layer; and (iii) subjecting the resulting 3-D body to a further treatment that includes heating the 3-D body at a temperature just below the Tm of this oligomer so as to undergo a solid state conversion of the oligomer to a high Mw thermoplastic material. These procedures are similar to the procedures used in the case of Type 1 Prepolymer because, after all, the preparation of the resulting polymers went through essentially step-wise growth mechanisms.

### Processes and Needed Hardware

Referring to FIG. 1-FIG. 3, the process involves intermittently or continuously dispensing strands of the fluent material composition through an orifice of a dispensing nozzle 40 to deposit onto a surface of a support member 44. During this dispensing procedure, the support member and the dispensing head are moved (preferably under the control of a computer 50 and a controller/indexer 54) with respect to each other along selected directions in a predetermined pattern on an X-Y plane defined by first (X-) and second (Y-) directions and along the Z-direction perpendicular to the X-Y plane. The three mutually orthogonal X-, Y- and Z-directions form a Cartesian coordinate system. These relative movements are effected so that the material composition can be deposited essentially point by point and layer by layer to build a multiple-layer object according to a computer-aided design (CAD) drawing of a 3-D object.

In one preferred embodiment, an optional heating provision (e.g., heating elements) is attached to, or contained in, the dispensing head to control the physical and chemical state of the material composition; e.g., to help maintain it in a fluent state. A temperature sensing means (e.g. a thermocouple) and a temperature controller can be employed to regulate the temperature of the dispensing head. Heating means are well known in the art.

Advantageously, the dispensing head may be designed to comprise a plurality of discharge orifices. In another embodiment of the presently invented method, the dispensing head may comprise a plurality of dispensing nozzles, each comprising a single orifice or a plurality of discharge orifices. Such a multiple-nozzle dispensing system is desirable because an operator may choose to use different material compositions to build different portions of an object. Different material compositions could include different colorants. There are many commercially available fluid delivery devices and dispensing nozzles that are capable of dispensing the material compositions in the presently invented method.

FIG. 2 schematically shows a screw extruder that can be used as a fluid delivery device. The feedstock material composition in a powder, flake, granule, or pellet form, may be fed through a hopper 72 into one end of a cylindrical barrel 75. Placed inside the barrel is a screw 76 which, when driven by a motor, will convey the feedstock material forward (from left to right in FIG. 2). The barrel is equipped with heating bands 74 which help to bring the material composition to a liquid state (e.g., by melting the prepolymer). The liquid material composition is pushed to cumulate at a chamber 78 prior to being forced through a die 79 to enter a control valve 38a (e.g., an electrically operated solenoid valve). The valve 38a can be switched between ON and OFF positions to regulate the flow of the liquid material through a discharge orifice 41a of an extrusion nozzle 40a. This dispensing nozzle can be as simple as a cone- or cylinder-shaped metal piece with a small fluid channel (orifice size preferably between 0.1 mm and 0.3 mm).

FIG. 3a schematically shows a gear pump that can be used as a fluid delivery device. The device includes a heated chamber 25 to accommodate the liquid material composition 26 (containing a prepolymer melt). A motor 20, through a drive shaft 23, drives a pair of counter-acting gears 28 to pump the liquid material through a bore 30 into a channel 32. A control valve 38 in flow communication with the channel 32 is employed to regulate the flow of the fluid through the dispensing nozzle 40. When the control valve, which is controlled by a machine controller through electric cords 46, is at ON position, the fluid is extruded out of the nozzle in an essentially continuous strand form. When the valve 38 is at OFF position, no fluid is allowed to go through the valve 38 and any excess fluid in channel 32 will back-flow through channel 34 and bore 36 (in a check vale) to re-enter the heated chamber 25 when the drive motor continues to rotate. This back-flow mechanism is a preferred feature to have since it will help to regulate the fluid pressure inside channel 32; this pressure would affect the extrusion rate of liquid strands through the dispensing nozzle 40.

FIG. 3b schematically shows another fluid material delivery device in which the dispensing pressure can be maintained constant and can be readily changed. A compressed air source 70 supplies pressurized air through an adjustable valve 66 into a fluid reservoir 62 which supplies the liquid material composition through a control valve 38 to an extrusion nozzle 40. A safety valve 68 is installed in the pipe line for releasing the pressure when needed. The build material containing the prepolymer may be fed into the reservoir 62 through a feed-through access 64. Optional heating elements may be provided to maintain the material in the reservoir in a fluent state. When the pressure-regulating valve 66 is switched open, the fluid material is under a constant pressure. When the control valve 38, solenoid or air-controlled, is turned on, a constant flow of fluent material is dispensed through an orifice of the dispensing nozzle 40. With a lower air pressure, the flow rate is smaller, resulting in a smaller-sized material strand coming out of the orifice. If the air pressure is increased on demand, a higher flow rate leads to a greater over-all object-building rate.

FIG. 3c schematically shows a piston-driven fluid delivery device, which includes a heated chamber 84 to accommodate a liquid material composition. The chamber temperature is measured by a thermal sensor or thermometer 86. A piston 82 is driven to move up and down. When going downward, the piston pushes the liquid material composition through an orifice 41 of an extrusion nozzle 40b to form continuous strands of material composition that build up the 3-D object 42 point by point and layer by layer.

Referring again to FIG. 1, the support member 44 is located in close, working proximity to (at a predetermined initial distance from) the dispensing nozzle 40. The upper surface of the support member preferably has a flat region sufficiently large to accommodate the first few layers of deposited material composition. The support member and the dispensing head are equipped with mechanical drive means for moving the support member relative to the movable dispensing head in three dimensions along “X,” “Y,” and “Z” axes in a predetermined sequence and pattern, and for displacing the dispensing head a predetermined incremental distance relative to the support member. This can be accomplished, for instance, by allowing the support member and the dispensing head to be driven by three separate linear motion devices, which are powered by three stepper motors. Linear motion devices and X-Y-Z gantry tables are commercially available. Z-axis movements are effected to displace the nozzle relative to the support member and, hence, relative to each layer deposited prior to the start of the formation of each successive layer. This will make it possible to form multiple layers of predetermined thicknesses, which build up on each other sequentially as the material composition solidifies after being discharged from the orifice. Instead of stepper motors, many other types of drive means can be used, including linear motors, servo motors, synchronous motors, D.C. motors, and fluid motors.

As another preferred embodiment of the present invention, the apparatus used for the method may comprise a plurality of dispensing nozzles (e.g., 5 nozzles for 5 different colorants: white, black, blue, yellow and red) each having flow-passage means (chamber or channel) therein connected to a dispensing orifice at one end thereof. Each additional nozzle is provided with a separate supply of a different material composition, and means (fluid delivery device) for introducing this material composition into the flow-passage so that the material composition is in a fluent state just prior to discharge. Each nozzle can have one discharge orifice or a multiplicity of discharge orifices.

Another embodiment of the present invention involves using a multiple-nozzle apparatus as just described. However, at least one nozzle is supplied with a material for depositing a support structure for supporting those portions or features of the 3-D object that cannot support themselves (e.g., overhangs and isolated islands). Alternatively, a separate dispensing device may be used to building the support structure. The support structure material used may be a low melting point materials such as wax for easy removal at a later stage.

### Computer-Aided Design and Process Control

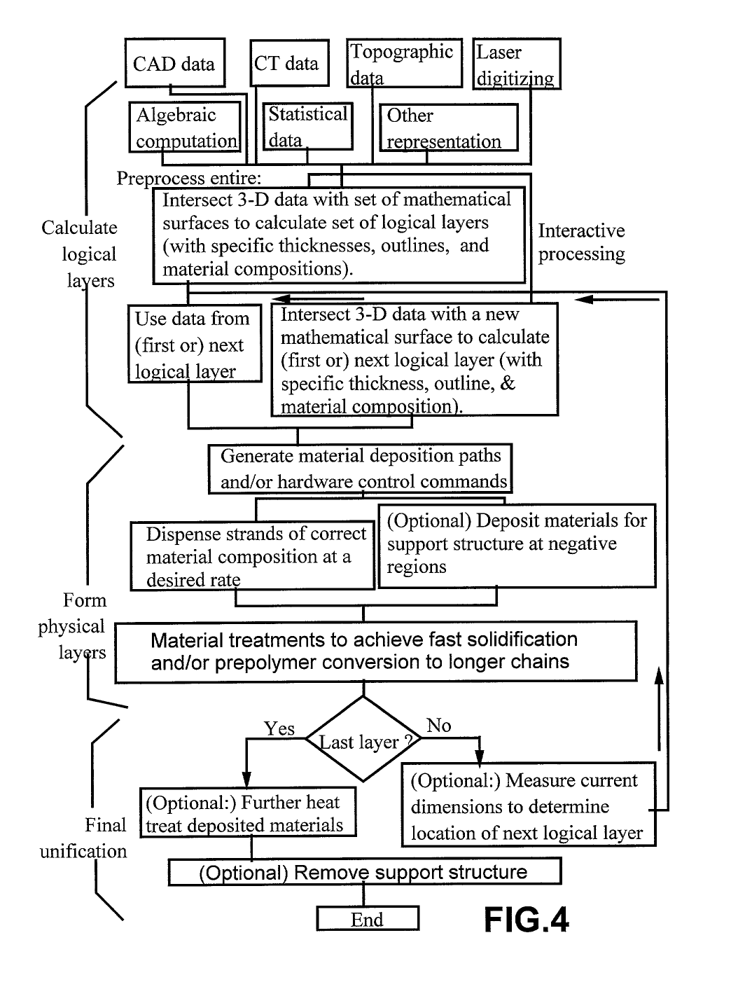

A preferred embodiment of the present invention is a solid freeform fabrication method in which the execution of various steps may be illustrated by the flow chart of FIG. 4. The method begins with the creation of a mathematical model (e.g., via computer-aided design, CAD), which is a data representation of a 3-D object. This model is stored as a set of numerical representations of layers which, together, represent the whole object. A series of data packages, each data package corresponding to the physical dimensions and shape of an individual layer, is stored in the memory of a computer in a logical sequence.

In one preferred approach, before the constituent layers of a 3-D object are formed, the geometry of this object is logically divided into a sequence of mutually adjacent theoretical layers, with each theoretical layer defined by a thickness and a set of closed, nonintersecting curves lying in a smooth two-dimensional (2-D) surface. These theoretical layers, which exist only as data packages in the memory of the computer, are referred to as “logical layers.” This set of curves forms the “contour” of a logical layer or “cross section”. In the simplest situation, each 2-D logical layer is a plane so that each layer is flat, and the thickness is the same throughout any particular layer. However, this is not necessarily so in every case, as a layer may have any desired curvature and the thickness of a layer may be a function of position within its two-dimensional surface. The only constraint on the curvature and thickness function of the logical layers is that the sequence of layers must be logically adjacent. Therefore, in considering two layers that come one after the other in the sequence, the mutually abutting surfaces of the two layers must contact each other at every point, except at such points of one layer where the corresponding point of the other layer is void of material as specified in the object model.

As summarized in the top portion of FIG. 4, the data packages for the logical layers may be created by any of the following methods:

(1) For a 3-D computer-aided design (CAD) model, by logically “slicing” the data representing the model,

(2) For topographic data, by directly representing the contours of the terrain,

(3) For a geometrical model, by representing successive curves which solve “z=constant” for the desired geometry in an x-y-z rectangular coordinate system, and

(4) Other methods appropriate to data obtained by computer tomography (CT), magnetic resonance imaging (MRI), satellite reconnaissance, laser digitizing, line ranging, or other reverse engineering methods of obtaining a computerized representation of a 3-D object.

An alternative to calculating all of the logical layers in advance is to use sensor means to periodically measure the dimensions of the growing object as new layers are formed, and to use the acquired data to help in the determination of where each new logical layer of the object should be, and possibly what the curvature and thickness of each new layer should be. This approach, called “adaptive layer slicing”, could result in more accurate final dimensions of the fabricated object because the actual thickness of a sequence of stacked layers may be different from the simple sum of the intended thicknesses of the individual layers.

The closed, nonintersecting curves that are part of the representation of each layer unambiguously divide a smooth two-dimensional surface into two distinct regions. In the present context, a “region” does not mean a single, connected area. Each region may consist of several island-like subregions that do not touch each other. One of these regions is the intersection of the surface with the desired 3-D object, and is called the “positive region” of the layer. The other region is the portion of the surface that does not intersect the desired object, and is called the “negative region.” The curves that demarcate the boundary between the positive and negative regions, and are called the “outline” of the layer. In the present context, the material composition is allowed to be deposited in the “positive region” while, optionally, a wax or a low-melting material may be deposited in certain parts or all of the “negative region” in each layer to serve as a support structure.

As a specific example, the geometry of a three-dimensional object may be converted into a proper format utilizing commercially available CAD/Solid Modeling software. A commonly used format is the stereo lithography file (.STL), which has become a defacto industry standard for rapid prototyping. The object image data may be sectioned into multiple layers by a commercially available software program. Each layer has its own shapes and dimensions, which define both the positive region and the negative region. These layers, each being composed of a plurality of segments, when combined together, will reproduce a shape of the intended object.

In one embodiment of the present invention, the method involves depositing a lower-melting material in all of the negative regions in each layer to serve as a support structure. This support structure may be removed at a later stage or at the conclusion of the object-building process. The presence of a support structure (occupying the negative region of a layer), along with the object-building material (the positive region), will completely cover a layer before proceeding to build a subsequent layer.

As another embodiment of the present invention, the 3-D object making process comprise additional steps of (1) evaluating the data files of the CAD drawing representing the intended object to locate any un-supported feature of the object and (2) responsive to this evaluation step, determining a support structure for the unsupported feature. This can be accomplished by, for instance, (a) creating a plurality of segments defining the support structure, (b) generating programmed signals corresponding to each of the segments defining this support structure in a predetermined sequence; and (c) operating a separate material deposition device, in response to these programmed signals for building the support structure.

When a multi-material object is desired, these segments are preferably sorted in accordance with their material compositions. This can be accomplished by taking the following procedure: When the stereo lithography (.STL) format is utilized, the geometry is represented by a large number of triangular facets that are connected to simulate the exterior and interior surfaces of the object. The triangles may be so chosen that each triangle covers one and only one material composition. In a conventional .STL file, each triangular facet is represented by three vertex points each having three coordinate points, (x₁,y₁,z₁), (x₂,y₂,z₂) and (x₃,y₃,z₃), and a unit normal vector (i,j,k). Each facet is now further endowed with a material composition code to specify the desired material composition. This geometry representation of the object is then sliced into a desired number of layers expressed in terms of any desired layer interface format (such as Common Layer Interface or CLI format). During the slicing step, neighboring data points with the same material composition code on the same layer may be sorted together. These segment data in individual layers are then converted into programmed signals (data for selecting dispensing heads and tool paths) in a proper format, such as the standard NC G-codes commonly used in computerized numerical control (CNC) machinery industry. These layering data signals may be directed to a machine controller which selectively actuates the motors for moving the dispensing head with respect to the support member, activates signal generators, drives the material supply means (if existing) for the dispensing head, drives the optional vacuum pump means, and operates optional temperature controllers, etc. It should be noted that although .STL file format has been emphasized in this paragraph, many other file formats have been employed in different commercial rapid prototyping and manufacturing systems. These file formats may be used in the presently invented system and each of the constituent segments for the object geometry may be assigned a material composition code if an object of different material compositions at different portions is desired.

The three-dimensional motion controller is electronically linked to the mechanical drive means and is operative to actuate the mechanical drive means (e.g., those comprising stepper motors) in response to “X”, “Y”, “Z” axis drive signals for each layer received from the CAD computer. Controllers that are capable of driving linear motion devices are commonplace. Examples include those commonly used in a milling machine.

Numerous software programs have become available that are capable of performing the presently specified functions. Suppliers of CAD/Solid Modeling software packages for converting CAD drawings into .STL format include SDRC (Structural Dynamics Research Corp. 2000 Eastman Drive, Milford, Ohio 45150), Cimatron Technologies (3190 Harvester Road, Suite 200, Burlington, Ontario L7N 3N8, Canada), Parametric Technology Corp. (128 Technology Drive, Waltham, Mass. 02154), and Solid Works (150 Baker Ave. Ext., Concord, Mass. 01742). Optional software packages may be utilized to check and repair .STL files which are known to often have gaps, defects, etc. AUTOLISP can be used to convert AUTOCAD drawings into multiple layers of specific patterns and dimensions.

Several software packages specifically written for rapid prototyping have become commercially available. These include (1) SOLIDVIEW RP/MASTER software from Solid Concepts, Inc., Valencia, Calif.; (2) MAGICS RP software from Materialise, Inc., Belgium; and (3) RAPID PROTOTYPING MODULE (RPM) software from Imageware, Ann Arbor, Mich. These packages are capable of accepting, checking, repairing, displaying, and slicing .STL files for use in a solid freeform fabrication system. MAGICS RP is also capable of performing layer slicing and converting object data into directly useful formats such as Common Layer Interface (CLI). A CLI file normally comprises many “polylines” with each polyline being an ordered collection of numerous line segments. These and other software packages (e.g. Bridgeworks from Solid Concepts, Inc.) are also available for identifying an un-supported feature in the object and for generating data files that can be used to build a support structure for the un-supported feature. The support structure may be built by a separate fabrication tool or by the same dispensing head that is used to build the object.

A company named CGI (Capture Geometry Inside, currently located at 15161 Technology Drive, Minneapolis, Minn.) provides capabilities of digitizing complete geometry of a three-dimensional object. Digitized data may also be obtained from computed tomography (CT) and magnetic resonance imaging (MRI), etc. These digitizing techniques are known in the art. The digitized data may be re-constructed to form a 3-D model on the computer and then converted to .STL files.

Sensor means may be attached to proper spots of the support member or the material deposition device (e.g., dispensing head) to monitor the physical dimensions of the physical layers being deposited. The data obtained are fed back periodically to the computer for re-calculating new layer data. This option provides an opportunity to detect and rectify potential layer variations; such errors may otherwise cumulate during the build process, leading to significant part inaccuracy. Many prior art dimension sensors may be selected for use in the present apparatus.

As indicated earlier, the most popular file format used by all commercial rapid prototyping machines is the .STL format. The .STL file format describes a CAD model's surface topology as a single surface represented by triangular facets. By slicing through the CAD model simulated by these triangles, one would obtain coordinate points that define the boundaries of each cross section. It is therefore convenient for a dispensing head to follow these coordinate points to trace out the perimeters (peripheral contour lines) of a layer cross section. These perimeters may be built with selected material composition patterns. These considerations have led to the development of another embodiment of the present invention. This is a method as set forth in the above-cited process, wherein the moving step includes the step of moving the dispensing head and the support member relative to one another in a direction parallel to the X-Y plane according to a first predetermined pattern to form an outer boundary of one selected material composition or a distribution pattern of different material compositions onto the support member. The outer boundary defines an exterior surface of the object.

Another embodiment is a process as set forth in the above paragraph, wherein the outer boundary defines an interior space in the object, and the moving step further includes the step of moving the dispensing head and the base member relative to one another in one direction parallel to the X-Y plane according to at least one other predetermined pattern to partially or completely fill this interior space with a selected material composition. The interior space does not have to have the same material composition as the exterior boundary. The interior space may be built with materials of a spatially controlled composition comprising one or more distinct types of materials. The material compositions may be deposited in continuously varying concentrations of distinct types of materials. This method may further comprise the steps of (1) creating a geometry of the object on a computer with the geometry including a plurality of segments defining the object and materials to be used; and (2) generating program signals corresponding to each of these segments in a predetermined sequence, wherein the program signals determine the movement of the dispensing head and the support member relative to one another in the first predetermined pattern and at least one other predetermined pattern.

We claim:

1. A freeform fabrication method for making a three-dimensional object from a design created on a computer, comprising:
(a) providing a support member by which said object is supported while being constructed;
(b) operating a dispensing head having at least a dispensing nozzle for dispensing continuous strands of a material composition in a fluent state at a first temperature onto said support member, said material composition comprising a reactive prepolymer with a melting point above 23° C. and said first temperature being greater than said melting point;
(c) operating material treatment means disposed a distance from said dispensed strands of material composition for causing said material composition to rapidly achieve a rigid state in which said material composition is substantially solidified and built up in a form of said three-dimensional object, said material treatment means comprising means for converting said reactive prepolymer to a thermoplastic resin; and
(d) operating control means for generating control signals in response to coordinates of said design of said object and controlling the position of said dispensing head relative to said support member in response to said control signals to control dispensing of said material composition for constructing said object.

2. A method of claim 1 wherein said material treatment means comprise heating means to heat up said dispensed strands of the material composition to a second temperature being approximately equal to or higher than said first temperature so as to rapidly convert said prepolymer in said dispensed strands to a higher molecular weight thermoplastic resin with a melting point substantially higher than said second temperature.

3. A method of claim 1 wherein said material treatment means comprise
(a) means for providing a forming environment above said support member with said environment being at a second temperature that is substantially lower than said first temperature to facilitate the solidification of said dispensed strands; and
(b) heating means to heat said 3-D object being built for converting said prepolymer to a higher molecular weight thermoplastic resin at a third temperature being approximately equal to or lower than the melting point of said prepolymer so as to execute said conversion procedure in a substantially rigid or solid state.

4. A method of claim 1 wherein said dispensing head comprises a fluid delivery device selected from the group consisting of a gear pump, positive-displacement pump, piston-driven pump, air-operated pump, syringe, screw extruder, or combinations thereof.

5. A method of claim 1 wherein said material composition includes a catalyst and/or accelerator for promoting the rapid conversion of said prepolymer to a higher molecular weight thermoplastic resin.

6. A method of claim 1 wherein said control means include servo means for indexing and positioning said dispensing head relative to said support member.

7. A method of claim 1 wherein said dispensing head further comprises a control valve means for regulating the flow of said material composition through said dispensing nozzle.

8. A method of claim 3 wherein said prepolymer is prepared by using a step-growth polymerization.

9. A method of claim 1 wherein said prepolymer is selected from the group consisting of oligomer precursors to linear polyester, polyamide, polyurethane, polyimide, polysulfide, and copolymers thereof.

10. A method of claim 1 wherein said prepolymer is prepared by using a ring-opening polymerization.

11. A method of claim 1 wherein said prepolymer comprises a cyclic oligomer.

12. A method of claim 11 wherein said cyclic oligomer is selected from the group consisting of cyclic organic carbonate, thiocarbonate, heterocarbonate, imide, polyphenylene ether- polycarbonate, ester, amide, etherketone, ethersulfone, and mixtures thereof.

13. A method of claim 1 wherein said material composition comprises a colorant.

14. A method of claim 10 wherein said prepolymer contains an activated anionic chain from caprolactam.

15. A method of claim 1 wherein said dispensing head comprises a plurality of dispensing nozzles.

16. A method of claim 1, wherein said dispensing head comprises a plurality of discharge orifices.

17. A freeform fabrication method for making a three-dimensional object comprising:
(a) providing at least one material composition in a fluent state, said composition comprising a reactive prepolymer;
(b) feeding said at least one material composition to a dispensing head having at least one dispensing nozzle with at least one discharge orifice of a predetermined size;
(c) dispensing continuous strands of said at least one material composition from said at least one dispensing nozzle onto a support member disposed at a predetermined initial distance from said dispensing nozzle;
(d) operating material treatment means for further extending the chain length of said prepolymer in said dispensed strands to obtain a higher molecular weight thermoplastic resin; and
(e) during said dispensing step, moving said at least one dispensing nozzle and said support member relative to one another in a plane defined by first and second directions and in a third direction orthogonal to said plane to form said at least one material composition into a three-dimensional shape of said object.

18. A freeform fabrication method of claim 17, wherein said dispensing head has at least two discharge orifices for dispensing at least two different material compositions for building a multi-material object.

19. A freeform fabrication method of claim 17, further including the step of operating said dispensing head or a separate dispensing device for building a support structure for an un-supported feature of said object.

20. A freeform fabrication method of claim 17, wherein said moving step includes the steps of moving said at least one dispensing nozzle and said support member relative to one another in a direction parallel to said plane to form a first layer of said at least one material composition on said support member, moving said dispensing nozzle and said support member away from one another in said third direction by a predetermined layer thickness distance, and dispensing a second layer of said at least one material composition onto said first layer while simultaneously moving said dispensing nozzle and said support member in said direction parallel to said plane, whereby said second layer adheres to said first layer.

21. A freeform fabrication method of claim 20, further including the steps of forming multiple layers of said at least one material composition on top of one another by repeated dispensing of said at least one material composition as said dispensing nozzle and said support member are moved relative to one another in one direction parallel to said plane, with said dispensing nozzle and said support member being moved away from one another in said third direction by a predetermined layer thickness after each preceding layer has been formed.

22. A freeform fabrication method of claim 17, further including the steps of:
creating a geometry representation of said three-dimensional object on a computer, said geometry representation including a plurality of segments defining said object;
generating programmed signals corresponding to each of said segments in a predetermined sequence; and
moving said dispensing nozzle and said support member relative to one another in response to said programmed signals.

23. A freeform fabrication method of claim 17, wherein said moving step includes the step of moving said dispensing nozzle and said support member relative to one another in a direction parallel to said plane according to a first determined pattern to form an outer boundary of said mixture on said support member, said outer boundary defining an exterior surface of said object.

24. A freeform fabrication method of claim 23, wherein said outer boundary defines an interior space in said object, and said moving step further includes the step of moving said dispensing nozzle and said support member relative to one another in said direction parallel to said plane according to at least one other predetermined pattern to fill said interior space with said at least one material composition.

25. A freeform fabrication method of claim 24, further comprising the steps of creating a geometry representation of said three-dimensional object on a computer, said geometry representation including a plurality of segments defining said object, and generating programmed signals corresponding to each of said segments in a predetermined sequence, wherein said programmed signals determine said movement of said dispensing nozzle and said support member relative to one another in said first predetermined pattern and said at least one other predetermined pattern.

26. A method as set forth in claim 17, further comprising
using dimension sensor means to periodically measure dimensions of the object being built;
using a computer to determine the thickness and outline of individual layers of said dispensed material composition being deposited in accordance with a computer aided design representation of said object; said computer being operated to calculate a first set of logical layers with specific thickness and outline for each layer and then periodically re-calculate another set of logical layers after comparing the dimension data acquired by said sensor means with said computer aided design representation in an adaptive manner.

27. A freeform fabrication method as set forth in claim 17, further comprising the steps of:
creating an image of said three-dimensional object on a computer with said image including a plurality of segments defining the object; each of said segments being coded with a material composition or color;
generating programmed signals corresponding to each of said segments in a predetermined sequence;
operating said dispensing head in response to said programmed signals to selectively dispense and deposit said at least one material composition containing desired colorants at predetermined proportions;
moving said dispensing head and said support member relative to one another in response to said programmed signals.

28. A method as set forth in claim 1 wherein said material composition further includes an additive or reinforcement selected from the group consisting of anti-oxidant, flame retardant, toughening agent, plasticizer, anti-static agent, particulate, fiber, whisker, or combinations thereof.
